(19) United States
(12) Patent Application Publication
(10) Pub. No.: US 2026/0009807 A1
(43) Pub. Date: Jan. 8, 2026

(54) SLIDE SCANNER AND AUTO-TEACHING METHOD OF SLIDE SCANNER

(71) Applicant: Vieworks Co., Ltd., Anyang-si (KR)

(72) Inventors: Jung Hoon CHOI, Suwon-si (KR); Jung-han SEO, Anyang-si (KR)

(21) Appl. No.: 19/259,699

(22) Filed: Jul. 3, 2025

(30) Foreign Application Priority Data
Jul. 4, 2024 (KR) 10-2024-0088484

(51) Int. Cl. G01N 35/00; H04N 23/50

(52) U.S. Cl. CPC G01N 35/00029; G01N 35/00584; H04N 23/50; G01N 2035/00138

(57) ABSTRACT

An embodiment relates to a slide scanner including an image capturing part configured to capture an image of a slide, and a loader including a gripper configured to grip the slide and load the slide onto the image capturing part or unload the slide loaded onto the image capturing part, in which the gripper is configured to grip a teaching jig including at least one detection part, and in which the slide scanner further includes a controller configured to control the loader so that the teaching jig moves to a teaching point at a predetermined position, the controller being configured to set a control reference for the loader by receiving a signal indicating that the detection part of the teaching jig is detected to be in contact with or in proximity to the teaching point.

### CROSS-REFERENCE TO RELATED APPLICATIONS

This application claims priority to and the benefit of Korean Patent Application No. 10-2024-0088484 filed in the Korean Intellectual Property Office on JULY 4, 2024, the entire contents of which are incorporated herein by reference.

### TECHNICAL FIELD

The present invention relates to a slide scanner configured to load a slide and capture an image of the slide.

### BACKGROUND ART

A scan device, which is used in conjunction with a microscope, is known. For example, a slide scanner is a device configured to automatically scan a slide on which a tissue sample to be inspected is placed and store, observe, and/or analyze images. The slide scanner is used to acquire images of tissue samples during various preclinical experiments or pathology tests.

Because the slide scanner captures images of tissue on the slide at several tens to several hundreds of times magnification, the slide scanner may capture images of the tissue with a small field of view (FOV), stitch the captured images, and create digital slide images (e.g., whole slide images (WSIs)).

The slide scanner utilizes a technology of automatically loading and unloading the slide by gripping and moving the slide, which is to be subjected to image-capturing, by using a gripper.

However, in case that an error occurs in a movement position of the gripper during the process of transferring the slide by using the gripper, a problem may occur in which the slide is damaged by colliding with a structure of the slide scanner, and the slide cannot be accurately loaded or unloaded.

### SUMMARY OF THE INVENTION

An object of the present invention is to provide a slide scanner capable of improving accuracy in transferring a slide by determining and correcting an error in a movement position of a gripper configured to transfer the slide.

Another object of the present invention is to provide an auto-teaching method for a slide scanner, the auto-teaching method being capable of improving accuracy in transferring a slide by determining a movement position of a gripper by a slide scanner and automatically correcting a movement amount of the gripper.

The present invention provides a slide scanner including an image capturing part configured to capture an image of a slide, and a loader including a gripper configured to grip the slide and load the slide onto the image capturing part or unload the slide loaded onto the image capturing part, in which the gripper is configured to grip a teaching jig including at least one detection part, and in which the slide scanner further includes a controller configured to control the loader so that the teaching jig moves to a teaching point at a predetermined position, the controller being configured to set a control reference for the loader by receiving a signal indicating that the detection part of the teaching jig is detected to be in contact with or in proximity to the teaching point.

In the embodiment, the teaching jig may include: a body configured to be gripped by a finger of the gripper; and the detection part provided on a mounting part connected to the body.

In addition, the detection part may include a first detection part, a second detection part, and a third detection part respectively corresponding to an X-axis direction, a Y-axis direction, and a Z-axis direction.

In addition, the detection part may be configured as any one of a micro-switch, a contact sensor, or a proximity sensor, and a sensing signal of the detection part may be transmitted to the controller in a wired or wireless manner.

In the embodiment, the teaching point may include at least one of a first teaching point corresponding to an X-axis direction, a second teaching point corresponding to a Y-axis direction, or a third teaching point corresponding to a Z-axis direction.

In addition, the first teaching point, the second teaching point, and the third teaching point may be respectively formed as surfaces perpendicular to the X-axis direction, the Y-axis direction, and the Z-axis direction.

In the embodiment, the first teaching point may include a first-first sub-teaching point and a first-second sub-teaching point formed at a predetermined interval in the X-axis direction, the second teaching point may include a second-first sub-teaching point and a second-second sub-teaching point formed at a predetermined interval in the Y-axis direction, and the third teaching point may include a third-first sub-teaching point and a third-second sub-teaching point formed at a predetermined interval in the Z-axis direction.

In the embodiment, the controller may correct position information of the teaching point in response to a signal of the detection part of the teaching jig.

In the embodiment, the controller may correct a driving control value of the loader in response to a detection signal of the detection part at the first-first and first-second sub-teaching points, the second-first and second-second sub-teaching points, or the third-first and third-second sub-teaching points.

In the embodiment, the teaching point may be a main stage of the image capturing part.

In the embodiment, the controller may determine whether the main stage and the loader are abnormal by comparing a displacement by which the main stage is moved and a displacement of the gripper detected by the detection part of the teaching jig.

In the embodiment, the slide scanner may further include: a slide rack having at least one slide storage part configured to store the slide, in which a rack position correction jig having a rack teaching portion is configured to be inserted into the slide rack, and in which the controller corrects position information of the slide rack by controlling the loader so that the detection part of the teaching jig is in contact with or in proximity to the rack teaching portion.

In the embodiment, the rack teaching portion may include at least one of a first rack teaching portion corresponding to an X-axis direction, a second rack teaching portion corresponding to a Y-axis direction, or a third rack teaching portion corresponding to a Z-axis direction.

In addition, the present invention provides an auto-teaching method for the slide scanner, the auto-teaching method including: step (a) of moving, by the controller, the gripper, which grips the teaching jig, to the teaching point; step (b) of receiving, by the controller, a detection signal, which indicates that the detection part of the teaching jig is in contact with or in proximity to the teaching point, from the detection part of the teaching jig; and step (c) of correcting, by the controller, position information of the teaching point or correcting a driving control value of the gripper in response to the detection signal.

In the embodiment, the teaching point may include a plurality of sub-teaching points formed at predetermined intervals in any one direction, the detection signal at the plurality of sub-teaching points may be received in steps (a) and (b), and an error in a movement amount of the gripper may be calculated in step (c).

In the embodiment, the teaching point may be a main stage provided in the image capturing part and configured such that the slide is loaded onto the main stage, steps (a) and (b) may be performed in a state in which the controller moves the main stage to a first position, steps (a) and (b) may be performed in a state in which the controller moves the main stage to a second position, and a displacement of the main stage and a displacement of the gripper may be compared in step (c).

According to the present invention, the movement position of the gripper provided in the slide scanner may be determined and automatically corrected, thereby preventing damage to the slide, which may be caused during the process of transferring the slide in the slide scanner, and improving the accuracy in loading and unloading the slide.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a slide scanner according to an embodiment of the present invention.

FIG. 2 is a front view of the slide scanner in a state in which a loader is excluded from the slide scanner according to the embodiment of the present invention.

FIG. 3 is a view illustrating a rear side of the loader of the slide scanner according to the embodiment of the present invention.

FIG. 4 is a view illustrating a state in which a gripper grips a slide in the slide scanner according to the embodiment of the present invention.

FIG. 5 is a view illustrating a state in which the gripper grips a teaching jig in the slide scanner according to the embodiment of the present invention.

FIG. 6 is a view illustrating an example of a teaching point provided to perform auto-teaching in the slide scanner according to the embodiment of the present invention.

FIG. 7 is a view illustrating another example of the teaching point provided to perform the auto-teaching in the slide scanner according to the embodiment of the present invention.

FIG. 8 is a view for explaining a state in which one side of the teaching jig is in contact with the teaching point in the slide scanner according to the embodiment of the present invention.

FIG. 9 is a view illustrating an example for correcting a movement position of the gripper with respect to a slide rack in the slide scanner according to the embodiment of the present invention.

FIG. 10 is a perspective view illustrating an example of a rack position correction jig inserted into the slide rack in the slide scanner according to the embodiment of the present invention.

FIG. 11 is a flowchart illustrating an auto-teaching method for the slide scanner according to the embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present invention, the specific descriptions of publicly known related configurations or functions will be omitted when it is determined that the specific descriptions may obscure the subject matter of the present invention. Further, the exemplary embodiments of the present invention will be described below, but the technical spirit of the present invention is not limited thereto and may, of course, be modified and variously carried out by those skilled in the art.

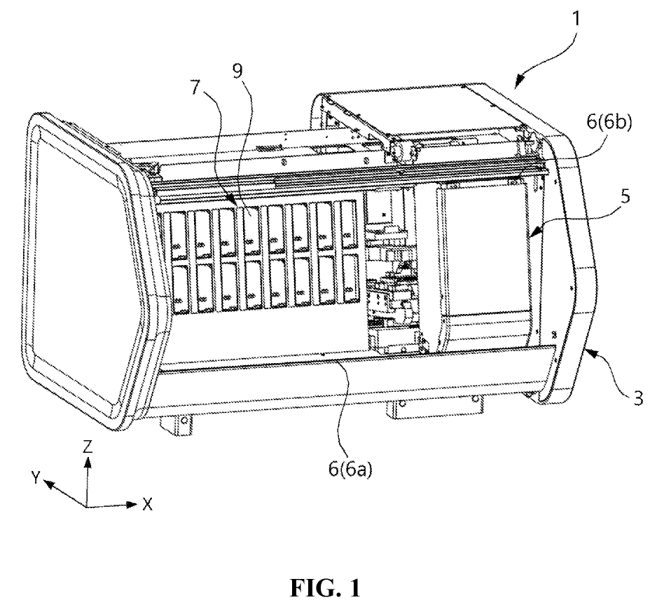

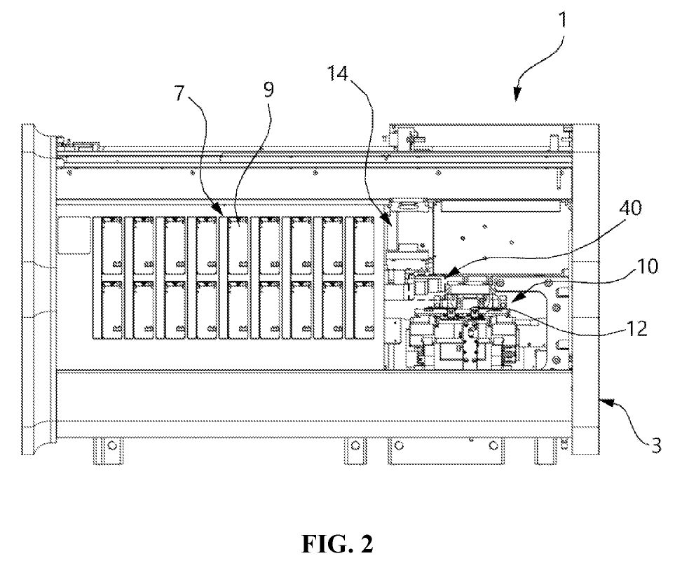

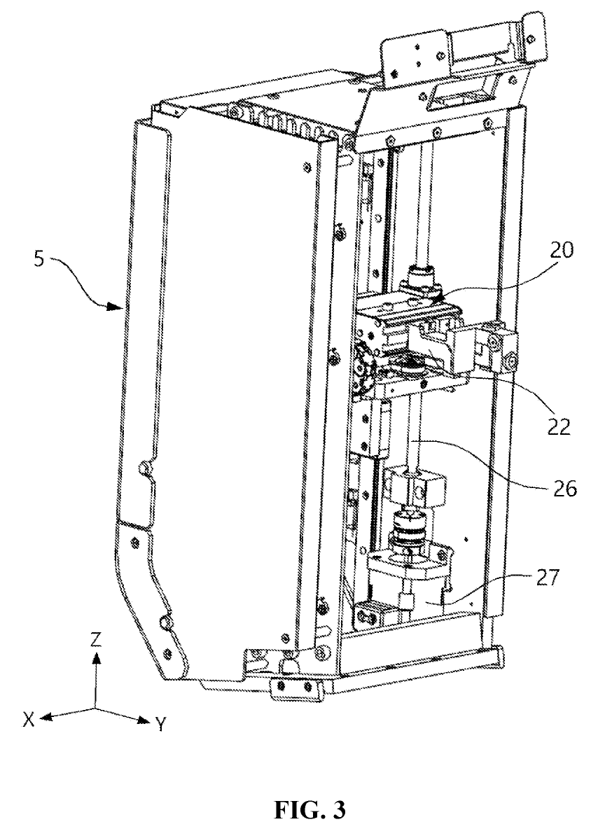

FIG. 1 is a perspective view of a slide scanner according to an embodiment of the present invention, and FIG. 2 is a front view of the slide scanner in a state in which a loader is excluded from the slide scanner according to the embodiment of the present invention. In addition, FIG. 3 is a view illustrating a rear side of the loader of the slide scanner according to the embodiment of the present invention.

A slide scanner 1 according to an embodiment of the present invention includes a casing 3, a loader 5, a slide rack 7, an image capturing part 10, a preview capturing part 14, and a controller 2 configured to control an operation of the slide scanner 1.

The casing 3 constitutes an external shape of the slide scanner 1 and defines a base on which other elements of the slide scanner 1 are mounted.

The loader 5 grips a slide S and transfers the slide S.

The slide rack 7 stores the slide S before or after scanning, and the slide rack 7 includes at least one slide storage part 9 configured to store the slide S.

The image capturing part 10 acquires an image by scanning the slide S. The image capturing part 10 includes a main stage 12 onto which the slide S is loaded. The image capturing part 10 may further include an image sensor, a lens, and the like to capture an image of the slide S loaded onto the stage 12. Because a typical technology may be applied to the optical components, such as the image sensor and the lens, included in the image capturing part 10, a specific additional description of the optical components will be omitted.

The preview capturing part 14 may create a preview image of the slide S. In the embodiment, the preview capturing part 14 may include a preview stage 16 and create an image of the entire slide by capturing a preview image of the slide S placed on the preview stage 16.

The controller 2 controls the operations of the slide scanner 1, such as an operation of transferring the slide by the loader 5, an operation of capturing the image of the image capturing part 10, an operation of capturing the preview of the preview capturing part 14, and the like. In the embodiment, the controller 2 may determine an error in transferring the slide by the loader 5 and correct the error in transferring the loader 5.

In the embodiment, a teaching point 40 may be formed at a predetermined position in the slide scanner 1 in order to determine a positional relationship between the image capturing part 10 and/or the preview capturing part 14 and the loader 5 configured to grip and transfer the slide S.

With reference to FIG. 3, the loader 5 configured to transfer the slide S includes a gripper 20 having fingers 22 configured to grip the slide S. The gripper 20 may move in X-axis, Y-axis, and Z-axis directions to transfer the slide S. In the embodiment, the gripper 20 may be moved in the Z-axis direction in a ball-screw manner by a Z-axis drive motor 27 and a Z-axis driving shaft 26. In addition, with reference to FIG. 1, the loader 5 may be moved in the X-axis direction along an X-axis movement rail 6 formed at a front side of the casing 3. In addition, as described below, the fingers 22 of the gripper 20 may be moved in the Y-axis direction. The fingers 22 of the gripper 20 may move in the X-axis, Y-axis, and Z-axis directions in this way, such that the fingers 22 of the gripper 20 may grip the slide S positioned at a predetermined position and move the slide S to a predetermined position. However, in the embodiment of the present invention, the configuration for moving the gripper 20 and the finger 22 is not limited to that described above. Various operating methods may be adopted. In some instances, the gripper 20 may be mounted on a robot arm, and the robot arm may move the gripper 20.

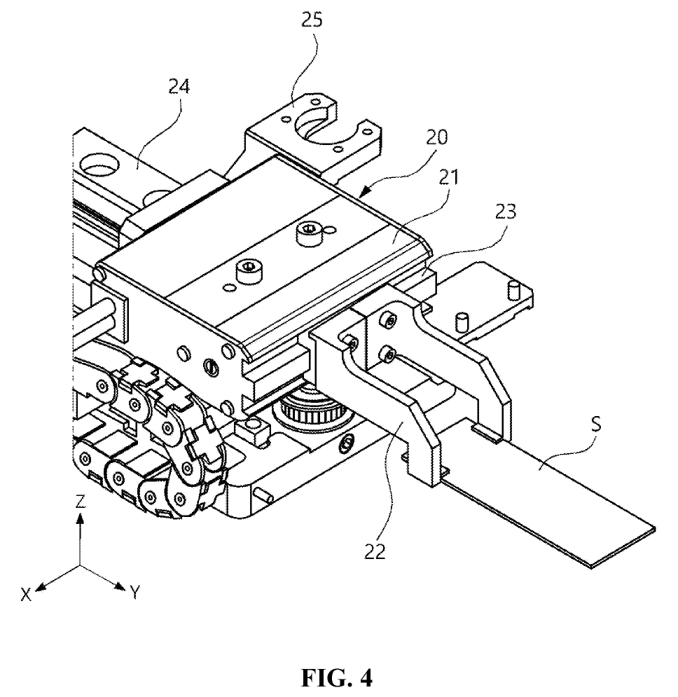

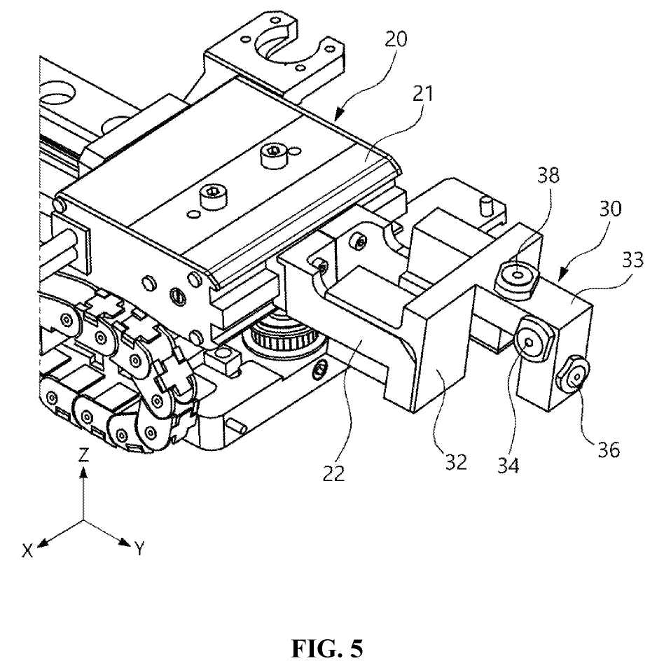

FIG. 4 is a view illustrating a state in which the gripper grips the slide in the slide scanner according to the embodiment of the present invention, and FIG. 5 is a view illustrating a state in which the gripper grips a teaching jig in the slide scanner according to the embodiment of the present invention.

With reference to FIG. 4, the gripper 20 includes a gripper body 21, and the pair of fingers 22 provided at one side of the gripper body 21. The fingers 22 may operate leftward and rightward (in the X-axis direction) along a finger rail 23 formed at one side of the gripper body 21 and grip the slide S. The gripper body 21 may move in the Y-axis direction along a Y-axis movement rail 24, such that the fingers 22 may move in the Y-axis direction. Meanwhile, the gripper 20 may have a Z-axis fixing part 25, such that the entire gripper 20 may be movably mounted on the Z-axis driving shaft 26.

With reference to FIG. 5, the fingers 22 of the gripper 20 may grip a teaching jig 30. The teaching jig 30 may serve to determine and correct a movement position of the gripper 20 and enable the controller 2 of the slide scanner 1 to determine positions of the fingers 22.

In the embodiment, the teaching jig 30 includes a body 32 configured to be gripped by the fingers 22, a mounting part 33 extending from the body 32, and a plurality of detection parts 34, 36, and 38 provided on the mounting part 33. The detection parts 34, 36, and 38 may detect whether the teaching jig 30 is in contact with or in proximity to another member. The detection parts 34, 36, and 38 may each be configured as a micro-switch, a proximity sensor, a pressure sensor configured to detect pressure, or a contact sensor such as a digital contact sensor. The detection parts 34, 36, and 38 may include a first detection part 34 corresponding to the X-axis direction, a second detection part 36 corresponding to the Y-axis direction, and a third detection part 38 corresponding to the Z-axis direction.

The teaching jig 30 may transmit signals, which are detected by the detection parts 34, 36, and 38, to the controller 2 in a wireless or wired manner.

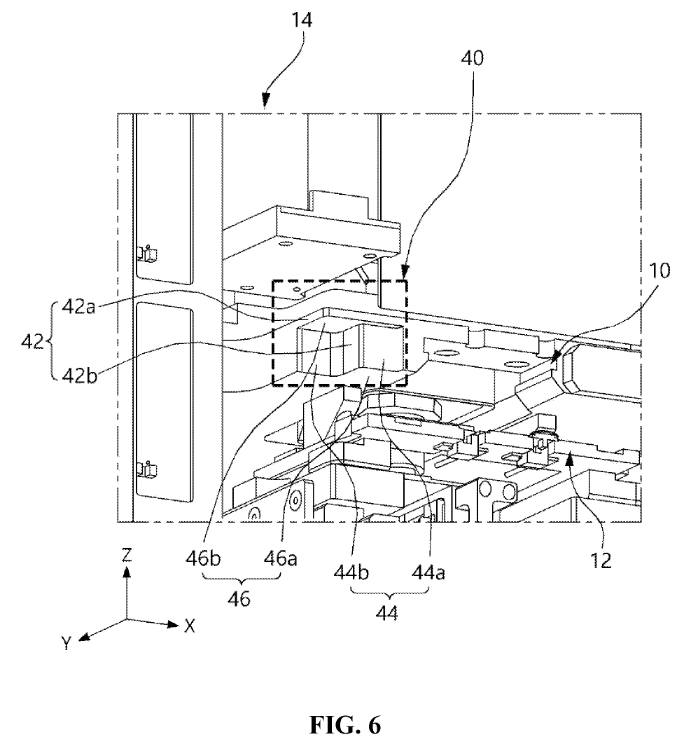

FIG. 6 is a view illustrating an example of the teaching point provided to perform auto-teaching in the slide scanner according to the embodiment of the present invention.

The gripper 20 may grip the slide S and load the slide S onto the main stage 12 of the image capturing part 10 or the preview stage 16 of the preview capturing part 14 or unload the slide S loaded onto the main stage 12 or the preview stage 16. Therefore, it is necessary to accurately recognize relative positions of the fingers 22 of the gripper 20 with respect to the main stage 12 or the preview stage 16. In the embodiment, the teaching point 40 may be provided at a position adjacent to the image capturing part 10 or the preview capturing part 14.

With reference to FIG. 6, the teaching point 40 may include a first teaching point 42 corresponding to the X-axis direction, a second teaching point 44 corresponding to the Y-axis direction, and a third teaching point 46 corresponding to the Z-axis direction. The first to third teaching points 42, 44, and 46 may be formed as surfaces respectively perpendicular to the X-axis direction, the Y-axis direction, and the Z-axis direction. In addition, the first to third teaching points 42, 44, and 46 each may include at least two sub-teaching points 42a/42b, 44a/44b, or 46a/46b, such that movement distances of the finger 22 in the X-axis direction, the Y-axis direction, and the Z-axis direction may be measured.

For example, in order to correct an X-axis direction movement of the gripper 20, the teaching jig 30 gripped by the fingers 22 of the gripper 20 is moved in the X-axis direction from the vicinity of the teaching point 40 toward the first teaching point 42. An X-axis direction position of the first teaching point 42 may be determined when the first detection part 34 of the teaching jig 30 is detected to be in contact with or in proximity to a first-first sub-teaching point 42a of the first teaching point 42. Next, the teaching jig 30 is moved to a first-second sub-teaching point 42b of the first teaching point 42. When the first detection part 34 is detected to be in contact with or in proximity to the first-second sub-teaching point 42b, an X-axis direction movement amount of the teaching jig may be calculated. Because an X-axis displacement between the first-first sub-teaching point 42a and the first-second sub-teaching point 42b is already known, a driving control value in the X-axis direction of the gripper may be corrected by comparing the driving control value in the X-axis direction of the gripper 20 with an actual movement amount.

For example, it is assumed that an actual X-axis displacement between the first-first sub-teaching point 42a and the first-second sub-teaching point 42b at the first teaching point 42 is x1, and a value, which is made by calculating the X-axis direction movement amount of the gripper 20 until the first-first sub-teaching point 42a is detected by the teaching jig 30 gripped by the fingers 22 of the gripper 20 and then the first-second sub-teaching point 42b is detected by the teaching jig 30 by moving the gripper 20 in the X-axis direction by using an encoder, a step motor, or the like, is x2. The controller 2 of the slide scanner 1 may correct the driving control value in the X-axis direction of the gripper 20 by using a difference between x2 and x1.

Likewise, when the second detection part 36 is detected to be in contact with or in proximity to a second-first sub-teaching point 44a and a second-second sub-teaching point 44b of the second teaching point 44 corresponding to the Y-axis direction as the teaching jig 30 is moved in the Y-axis direction, a Y-axis direction position of the second teaching point 44 may be determined, and a driving control value in the Y-axis direction of the gripper 20 may be corrected. In addition, when the third detection part 38 is detected to be in contact with or in proximity to a third-first sub-teaching point 46a and a third-second sub-teaching point 46b of the third teaching point 46 corresponding to the Z-axis direction as the teaching jig 30 is moved in the Z-axis direction, a Z-axis direction position of the third teaching point 46 may be determined, and a driving control value in the Z-axis direction of the gripper 20 may be corrected.

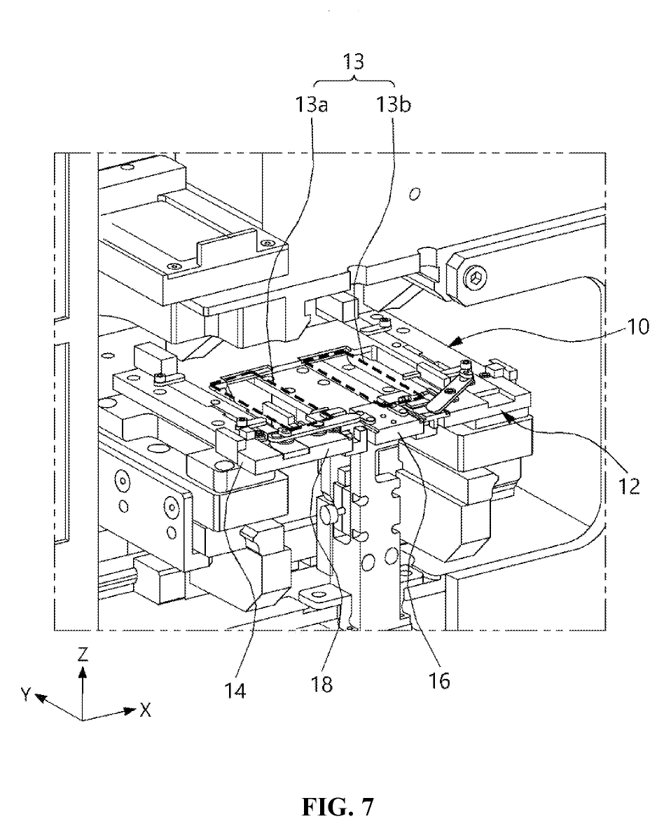

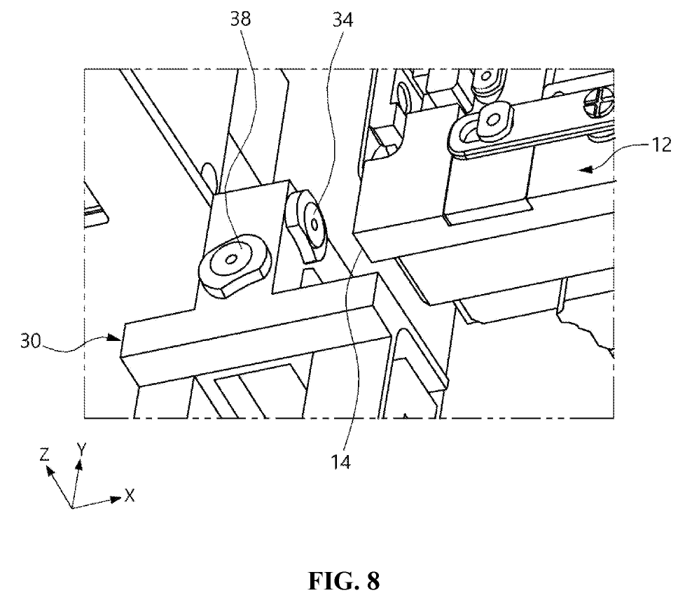

FIG. 7 is a view illustrating another example of the teaching point provided to perform the auto-teaching in the slide scanner according to the embodiment of the present invention, and FIG. 8 is a view for explaining a state in which one side of the teaching jig is in contact with the teaching point in the slide scanner according to the embodiment of the present invention.

With reference to FIG. 7, the main stage 12 of the image capturing part 10 may be utilized as a teaching point. The main stage 12 may have a slide loading portion 13 onto which at least one slide S is loaded. In the embodiment, the slide loading portion 13 may include a first slide loading portion 13a and a second slide loading portion 13b.

In the main stage 12, a surface 12a corresponding to the X-axis, a surface 12b corresponding to the Y-axis, and a surface 12c corresponding to the Z-axis may be used as the teaching points during the correction process using the teaching jig 30. For example, as illustrated in FIG. 8, the first detection part 34 of the teaching jig 30 may move toward the surface 12a corresponding to the X-axis of the main stage 12 and detect a position of the surface 12a corresponding to the X-axis.

Meanwhile, the main stage 12 may operate in the X-axis or Y-axis direction, and a positional relationship between the main stage 12 and the gripper 20 may be identified by using the teaching jig 30. For example, the surface 12a corresponding to the X-axis of the main stage 12 is primarily detected by using the first detection part 34 of the teaching jig 30, the main stage 12 is moved in the X-axis direction by a predetermined amount, and the surface 12a corresponding to the X-axis is secondarily detected by the first detection part 34 of the teaching jig 30. In case that a first displacement, by which the main stage 12 is moved in the X-axis direction, and a second displacement in the X-axis direction of the gripper 20, which is detected by the first detection part 34, are equal to each other or different from each other within a predetermined value, it may be determined that there is no abnormality. However, it may be determined that there is an abnormality in case that a difference between the first displacement and the second displacement has a predetermined value or more. For example, a difference between the first displacement and the second displacement may occur in case that the main stage 12 and the gripper 20 do not move in parallel with the X-axis direction.

For example, in a state in which the main stage 12 is positioned at a first position based on the X-axis direction, a first X-axis direction position of the main stage 12 at the first position is detected by the first detection part 34 of the teaching jig 30. Next, in a state in which the main stage 12 is moved to a second position based on the X-axis direction, a second X-axis direction position of the main stage 12 at the second position is detected by the first detection part 34 of the teaching jig 30. The normality may be determined when a difference between the X-axis direction movement amount of the main stage 12, which is based on a difference between the first position and the second position determined by an encoder value of an X-axis drive element of the main stage 12 configured to move the main stage 12 in the X-axis direction, and the X-axis direction movement amount of the gripper 20, which is based on a difference between the first X-axis direction position and the second X-axis direction position determined by an encoder value of an X-axis drive element of the gripper 20 configured to move the gripper 20 in the X-axis direction, is within a predetermined range. However, in case that a difference between an X-axis direction movement amount of the main stage 12 and an X-axis direction movement amount of the gripper 20 deviates from a predetermined range, this deviation may indicate that inspection or adjustment is required because any one of the X-axis direction drive element of the main stage 12 and the X-axis direction drive element of the gripper 20 has a problem or X-axis direction movement elements of the main stage 12 and the gripper 20 are misaligned.

In the same way, whether the main stage 12 and the gripper 20 are aligned in the Y-axis direction or whether the main stage 12 and the gripper 20 operate normally may be determined on the basis of a Y-axis direction movement of the main stage 12 and a Y-axis direction movement of the gripper 20.

The configuration in which the main stage 12 is utilized as the teaching point has been described with reference to FIGS. 7 and 8. However, the preview stage 16 of the preview capturing part 14 may also be utilized as a teaching point.

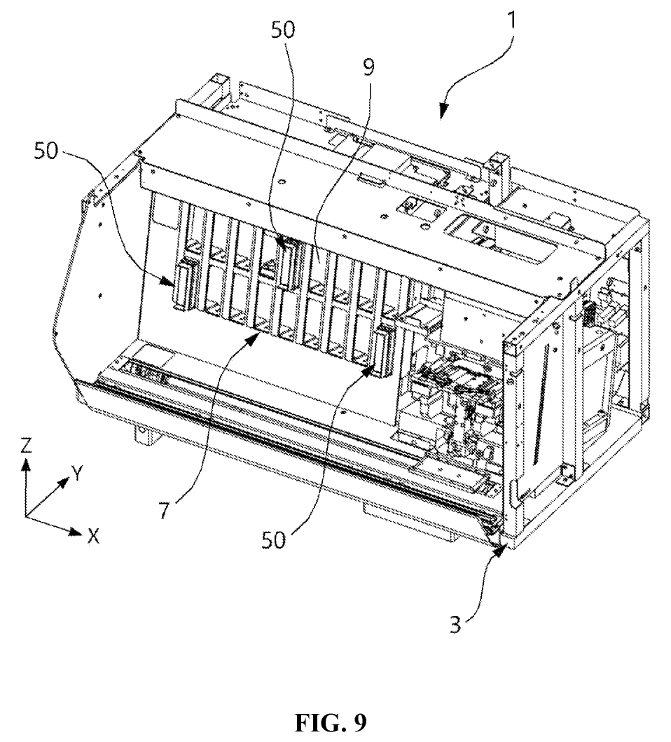

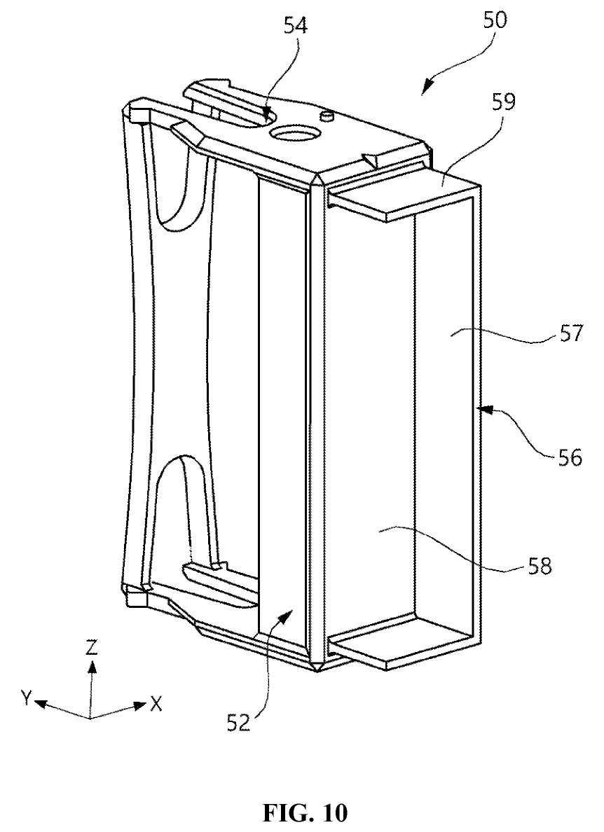

FIG. 9 is a view illustrating an example for correcting a movement position of the gripper with respect to the slide rack in the slide scanner according to the embodiment of the present invention, and FIG. 10 is a perspective view illustrating an example of a rack position correction jig inserted into the slide rack in the slide scanner according to the embodiment of the present invention.

The gripper 20 may move the slide S, which is stored in the slide rack 7, to the main stage 12 or the preview stage 16 and load the slide S. Further, the gripper 20 may unload the slide S from the main stage 12 or the preview stage 16 and move the slide S back to the slide rack 7. Therefore, it may be necessary to determine a position of the slide rack 7. The slide storage part 9 of the slide rack 7 or a structure at the periphery of the slide rack 7 may be used to determine and correct the movement position of the gripper 20. However, FIGS. 9 and 10 illustrate an example in which rack position correction jigs 50 are inserted into the slide storage parts 9 of the slide rack 7.

The rack position correction jig 50 includes a base 52, a rack insertion portion 54 formed at one side of the base 52 and mounted in the slide storage part 9, and a rack teaching portion 56 configured to be brought into contact with the detection parts 34, 36, and 38 of the teaching jig 30 gripped by the gripper 20. The rack teaching portion 56 includes a first rack teaching portion 57 corresponding to the X-axis direction, a second rack teaching portion 58 corresponding to the Y-axis direction, and third rack teaching portions 59 corresponding to the Z-axis direction. The first to third rack teaching portions 57, 58, and 59 may be configured in plate shapes respectively perpendicular to the X-axis, the Y-axis, and the Z-axis.

Meanwhile, in the slide scanner 1 according to the present invention, at least one of the teaching point 40, the main stage 12, the preview stage 16, and the rack position correction jig 50 may be utilized to set a reference position for operating the gripper 20 of the loader 5. The positions of the teaching point 40 and the preview stage 16 may be fixed in the casing 3 of the slide scanner 1. The main stage 12 may be moved to a particular position, and the rack position correction jig 50 may also be inserted into the particular slide rack 7. The positions of the teaching point 40, the main stage 12, the preview stage 16, and the rack position correction jig 50 are detected by the teaching jig 30, such that the reference position for controlling the operation of the loader 5 in the slide scanner 1 may be determined. That is, in the present invention, the controller 2 may determine the positions of the teaching points in the slide scanner 1 by detecting the teaching points by using the teaching jig 30. Meanwhile, the controller 2 may set a control reference for controlling the loader 5 by correcting or determining a transfer error of the gripper 20 or the alignment of the gripper 20 and the main stage 12 on the basis of the transfer amount at the teaching point.

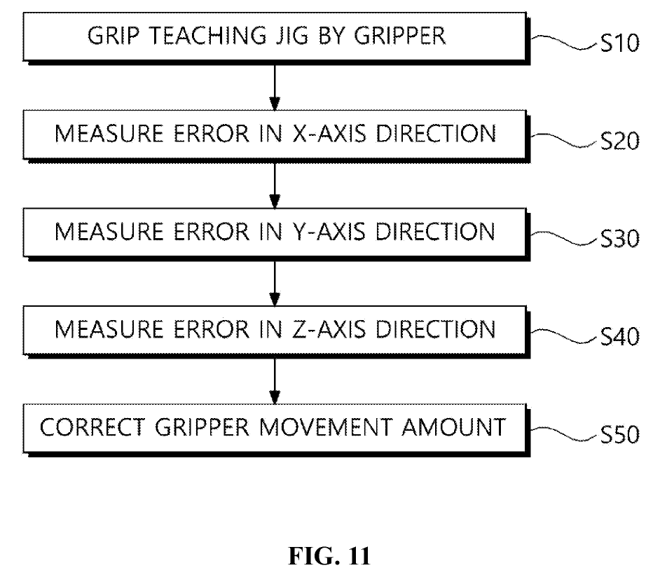

FIG. 11 is a flowchart illustrating an auto-teaching method for the slide scanner according to the embodiment of the present invention.

The gripper 20 grips the teaching jig 30 (S10).

The gripper 20 moves the teaching jig 30 to the teaching point of the slide scanner 1 and moves the teaching jig 30 in the X-axis direction, and the first detection part 34 of the teaching jig 30 is detected to be in contact with or in proximity to the teaching point corresponding to the X-axis direction, such that an error in the X-axis direction is measured (S20). The error in the X-axis direction may be a difference between a value stored as the X-axis direction position of the teaching point with respect to the gripper 20 of the loader 5 and an X-axis direction position of an actual teaching point. In addition, the error in the X-axis direction may be a difference between the driving control value in the X-axis direction of the gripper 20 and an actual movement amount. In addition, the error in the X-axis direction may be a difference between a displacement in the X-axis direction of the main stage 12 provided in the image capturing part 10 of the slide scanner 1 and a displacement in the X-axis direction of the gripper 20.

The gripper 20 moves the teaching jig 30 to the teaching point of the slide scanner 1 and moves the teaching jig 30 in the Y-axis direction, and the second detection part 36 of the teaching jig 30 is detected to be in contact with or in proximity to the teaching point corresponding to the Y-axis direction, such that an error in the Y-axis direction is measured (S30). The error in the Y-axis direction may be a difference between a value stored as the Y-axis direction position of the teaching point with respect to the gripper 20 of the loader 5 and a Y-axis direction position of an actual teaching point. In addition, the error in the Y-axis direction may be a difference between the driving control value in the Y-axis direction of the gripper 20 and an actual movement amount. In addition, the error in the Y-axis direction may be a difference between a displacement in the Y-axis direction of the main stage 12 provided in the image capturing part 10 of the slide scanner 1 and a displacement in the Y-axis direction of the gripper 20.

The gripper 20 moves the teaching jig 30 to the teaching point of the slide scanner 1 and moves the teaching jig 30 in the Z-axis direction, and the third detection part 38 of the teaching jig 30 is detected to be in contact with or in proximity to the teaching point corresponding to the Z-axis direction, such that an error in the Z-axis direction is measured (S40). The error in the Z-axis direction may be a difference between a value stored as the Z-axis direction position of the teaching point with respect to the gripper 20 of the loader 5 and a Z-axis direction position of an actual teaching point. In addition, the error in the Z-axis direction may be a difference between the driving control value in the Z-axis direction of the gripper 20 and an actual movement amount. In addition, in case that the main stage 12 provided in the image capturing part 10 of the slide scanner 1 may operate even in the Z-axis direction, the error in the Z-axis direction may be a difference between a displacement in the Z-axis direction of the main stage 12 and a displacement in the Z-axis direction of the gripper 20.

The controller 2 may correct the movement amount of the gripper 20 or correct a stored position value of the teaching point on the basis of the errors in the X-axis, Y-axis, and Z-axis directions (S50).

The device according to the embodiments of the present invention may include a processor, a memory configured to store and execute program data, a permanent storage such as a disc drive, a communication port configured to communicate with an external device, and user interface devices such as a touch panel, a key, and a button. Methods implemented by software modules or algorithms may be stored on computer-readable recording media as computer-readable codes or program instructions executable on the processor. In this case, examples of the computer-readable recording media include magnetic storage media (e.g., read-only memories (ROMs), random-access memories (RAMs), floppy discs, hard discs, etc.) and optical readout media (e.g., CD-ROMs, digital versatile discs (DVDs), etc.). The computer-readable recording media may be distributed to computer systems connected by networks, such that computer-readable codes may be stored and executed in a distributed manner. The medium may be readable by the computer, stored in the memory, and executed by the processor.

The embodiments of the present invention may be represented by functional block configurations and various processing steps. The function blocks may be implemented by various numbers of hardware or/and software configurations for performing particular functions. For example, the embodiment may employ integrated circuit configurations, such as memories, processing, logics, and look-up tables, that may perform various functions under the control of one or more microprocessors or other control devices. The constituent elements of the present invention may be executed as software programs or software elements. Similarly, the embodiments may be implemented in programming or scripting languages, such as C, C++, Java, assembler, and the like, including various algorithms implemented as data structures, processes, routines, or combinations of other programming configurations. The functional aspects may be implemented as algorithms executed by one or more processors. In addition, the embodiment may employ the technologies in the related art for electronic environment configuration, signal processing, and/or data processing. The terms "mechanism," "element," "means," and "component" may be used broadly and are not limited to mechanical and physical configurations. The terms may include the meaning of a series of routines of software in conjunction with a processor or the like.

The particular practices described in the embodiment are embodiments and are not intended to limit the scope of the embodiment in any way. For brevity of the specification, the description of electronic configurations, control systems, and software in the related art and other functional aspects of the systems may be omitted. In addition, line connections or connecting members between constituent elements illustrated in the drawings illustratively indicate functional connections, physical connections, and/or connections between circuits and may be represented as replaceable or additional and various functional connections, physical connections, and/or connections between circuits in an actual apparatus. In addition, a constituent element, which is not specifically mentioned together with the term such as "essentially" or "importantly", may not be a constituent element required to be necessarily applied to the present invention.

The above description is simply given for illustratively describing the technical spirit of the present invention, and those skilled in the art to which the present invention pertains will appreciate that various modifications, changes, and substitutions are possible without departing from the essential characteristics of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A slide scanner comprising:
an image capturing part configured to capture an image of a slide; and
a loader comprising a gripper configured to grip the slide and load the slide onto the image capturing part or unload the slide loaded onto the image capturing part,
wherein the gripper is configured to grip a teaching jig comprising at least one detection part, and
wherein the slide scanner further comprises a controller configured to control the loader so that the teaching jig moves to a teaching point at a predetermined position, the controller being configured to set a control reference for the loader by receiving a signal indicating that the detection part of the teaching jig is detected to be in contact with or in proximity to the teaching point.

2. The slide scanner of claim 1, wherein the teaching jig comprises:
a body configured to be gripped by a finger of the gripper; and
the detection part provided on a mounting part connected to the body.

3. The slide scanner of claim 2, wherein the detection part comprises a first detection part, a second detection part, and a third detection part respectively corresponding to an X-axis direction, a Y-axis direction, and a Z-axis direction.

4. The slide scanner of claim 3, wherein the detection part is configured as any one of a micro-switch, a contact sensor, or a proximity sensor, and a sensing signal of the detection part is transmitted to the controller in a wired or wireless manner.

5. The slide scanner of claim 1, wherein the teaching point comprises at least one of a first teaching point corresponding to an X-axis direction, a second teaching point corresponding to a Y-axis direction, or a third teaching point corresponding to a Z-axis direction.

6. The slide scanner of claim 5, wherein the first teaching point, the second teaching point, and the third teaching point are respectively formed as surfaces perpendicular to the X-axis direction, the Y-axis direction, and the Z-axis direction.

7. The slide scanner of claim 5, wherein the first teaching point comprises a first-first sub-teaching point and a first-second sub-teaching point formed at a predetermined interval in the X-axis direction, the second teaching point comprises a second-first sub-teaching point and a second-second sub-teaching point formed at a predetermined interval in the Y-axis direction, and the third teaching point comprises a third-first sub-teaching point and a third-second sub-teaching point formed at a predetermined interval in the Z-axis direction.

8. The slide scanner of claim 5, wherein the controller corrects position information of the teaching point in response to a signal of the detection part of the teaching jig.

9. The slide scanner of claim 7, wherein the controller corrects a driving control value of the loader in response to a detection signal of the detection part at the first-first and first-second sub-teaching points, the second-first and second-second sub-teaching points, or the third-first and third-second sub-teaching points.

10. The slide scanner of claim 1, wherein the teaching point is a main stage of the image capturing part.

11. The slide scanner of claim 10, wherein the controller determines whether the main stage and the loader are abnormal by comparing a displacement by which the main stage is moved and a displacement of the gripper detected by the detection part of the teaching jig.

12. The slide scanner of claim 1, further comprising:
a slide rack having at least one slide storage part configured to store the slide,
wherein a rack position correction jig having a rack teaching portion is configured to be inserted into the slide rack, and
wherein the controller corrects position information of the slide rack by controlling the loader so that the detection part of the teaching jig is in contact with or in proximity to the rack teaching portion.

13. The slide scanner of claim 12, wherein the rack teaching portion comprises at least one of a first rack teaching portion corresponding to an X-axis direction, a second rack teaching portion corresponding to a Y-axis direction, or a third rack teaching portion corresponding to a Z-axis direction.

14. An auto-teaching method for the slide scanner according to claim 1, the auto- teaching method comprising:
step (a) of moving, by the controller, the gripper, which grips the teaching jig, to the teaching point;
step (b) of receiving, by the controller, a detection signal, which indicates that the detection part of the teaching jig is in contact with or in proximity to the teaching point, from the detection part of the teaching jig; and
step (c) of correcting, by the controller, position information of the teaching point or correcting a driving control value of the gripper in response to the detection signal.

15. The auto-teaching method of claim 14, wherein the teaching point comprises a plurality of sub-teaching points formed at predetermined intervals in any one direction, the detection signal at the plurality of sub-teaching points is received in steps (a) and (b), and an error in a movement amount of the gripper is calculated in step (c).

16. The auto-teaching method of claim 14, wherein the teaching point is a main stage provided in the image capturing part and configured such that the slide is loaded onto the main stage, steps (a) and (b) are performed in a state in which the controller moves the main stage to a first position, steps (a) and (b) are performed in a state in which the controller moves the main stage to a second position, and a displacement of the main stage and a displacement of the gripper are compared in step (c).

17. The auto-teaching method of claim 14, wherein the teaching point comprises at least one of a first teaching point corresponding to an X-axis direction, a second teaching point corresponding to a Y-axis direction, or a third teaching point corresponding to a Z-axis direction.

18. The auto-teaching method of claim 14, wherein the slide scanner further comprises a slide rack having at least one slide storage part configured to store the slide,
wherein a rack position correction jig having a rack teaching portion is configured to be inserted into the slide rack, and
wherein the auto-teaching method further comprises step (d) of correcting, by the controller, position information of the slide rack by controlling the loader so that the detection part of the teaching jig is in contact with or in proximity to the rack teaching portion.
